(19) United States
(12) Patent Application Publication
(10) Pub. No.: US 2026/0195529 A1
(43) Pub. Date: Jul. 9, 2026

(54) AUTOMATIC MANAGEMENT OF MISALIGNED REFERENCES IN A CORPUS

(71) Applicant: International Business Machines Corporation, Armonk, NY (US)

(72) Inventors: Brianna Malcolm, Hyde Park, NY (US); Jeffrey Bisti, New Paltz, NY (US); TRISHELLE BYRD, Poughkeepsie, NY (US); Jayapreetha Natesan, Hopewell Junction, NY (US); Arielle Waller, Newburgh, NY (US)

(73) Assignee: International Business Machines Corporation, Armonk, NY (US)

(21) Appl. No.: 19/012,015

(22) Filed: Jan. 7, 2025

(51) Int. Cl. G06F 40/226; G06F 40/279; G06F 40/40

(52) U.S. Cl. CPC G06F 40/226; G06F 40/279; G06F 40/40

(57) ABSTRACT

A second set of topics represented in a second resource is extracted by inputting textual content of the second resource into a Large Language Model (LLM) operating in conjunction with a topic identification module. The second set of topics is compared with a first set of topics associated with a first resource and stored in a data repository. In response to comparing, a determination is made that a previously selected topic in the first set is absent in the second set of topics. An alternate resource is selected such that the alternate resource includes the previously selected topic. A reference to the first resource in the data repository is caused to be redirected to the alternate resource.

### BACKGROUND

The present invention relates generally to managing relevant documents in a corpus of data. More particularly, the present invention relates to a method, system, and computer program for automatic management of misaligned references in a corpus.

A corpus (plural: corpora) refers to a collection of data—generally including textual data, visual data, spoken language data, and data or document (resource) of any suitable form. The term corpus is often used in linguistic analysis, computational linguistics, or natural language processing (NLP), but can be used in the context of many other fields as well. In the context of linguistics, a corpus is a collection of written or spoken material that serves as a sample of language usage, and can be used to study language patterns, frequency of word use, syntactic structures, grammar, vocabulary, semantics, and other linguistic features. In NLP, corpora are used to train algorithms for tasks like speech recognition, machine translation, and text generation. In data analysis, a corpus is used for extracting useful information from large datasets.

The term “reference” as used herein is a method or mechanism to reach a resource located somewhere in a repository or on a network. Uniform Resource Locator (URL) links and file path names are some common references used to reach resources. A corpus includes not only resources but also references to resources. A reference to a resource is also interchangeably referred to herein as an association with the resource.

In large systems of information, it is a frequent case that references to resources change over time. A referenced resource may change over time and may not reflect the resource's initial purpose for inclusion in the corpus. For instance, a web page for a product may reference a blog that at one time contained helpful code samples but has changed its subject focus over time. Users frequently waste valuable time attempting to locate information within a resource due to inadequate or outdated linking and updating practices.

Additionally, while automated link checkers exist, they simply check for a 404—“Page Not Found” return code, or for a checksum mismatch. In a dynamic web environment and in Content Management Systems, which may attempt to rewrite 404 pages to contain suggested content, there is an opportunity to produce a more intelligent solution.

### SUMMARY

The illustrative embodiments provide for automatic management of misaligned references in a corpus. An embodiment includes extracting, by inputting textual content of a second resource into a Large Language Model (LLM) operating in conjunction with a topic identification module, a second set of topics represented in the second resource. The embodiment further includes comparing the second set of topics with a first set of topics associated with a first resource and stored in a data repository. The embodiment further includes determining, responsive to the comparing, that a previously selected topic in the first set is absent in the second set of topics. The embodiment further includes selecting an alternate resource such that the alternate resource includes the previously selected topic. The embodiment further includes causing a reference to the first resource in the data repository to be redirected to the alternate resource.

Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for automatic management of misaligned references in a corpus in accordance with an illustrative embodiment;

FIG. 3 depicts a flowchart of an example process for creating a new reference in accordance with an illustrative embodiment;

FIG. 4 depicts a flowchart of an example process for automatic management of the alignment of references in a corpus in accordance with an illustrative embodiment;

FIG. 5 depicts a block diagram of an example implementation for LDA in accordance with an illustrative embodiment;

FIG. 6 depicts block diagrams of example circumstances in the automatic management of misaligned references in accordance with an illustrative embodiment; and

FIG. 7 depicts an example process of replacing a resource in a corpus in accordance with an illustrative embodiment.

### DETAILED DESCRIPTION

References can become stale—or misaligned with an objective for the corresponding resource—over time. A reference to a resource can become misaligned as a result of a change in the location of the resource. A reference to a resource can become misaligned as a result of a change made to the resource that makes the resource unusable, less useful, or irrelevant for a purpose for which the resource was initially included in a corpus. A reference to a resource can become misaligned as a result of other better resources becoming available for that purpose.

The illustrative embodiments recognize that when the resource continues to exist at the reference location but has changed in some respect, a significant amount of time can be wasted in reviewing or using the resource only to find that the resource is no longer (as) useful as was initially thought. The illustrative embodiments further recognize that even at the time of initial inclusion of a resource into a corpus, the resource may not be the best source for the kind of information sought from the resource. Other better or more direct resources might be better candidates for inclusion in the corpus for the same purpose as was contemplated for the selected resource.

To solve these and other related problems associated with misaligned referenced resources in a corpus, the illustrative embodiments provide a method for automatic management of misaligned references in a corpus. The illustrative embodiments provide an improved method and system for managing a network of references between resources. One embodiment uses artificial intelligence (AI) to analyze the content and suitability of the resource that is being referenced and extracts a set of topics addressed in a resource. When creating a new reference to the resource, an embodiment prompts a user to identify any topics contained within the referenced resource that the user finds useful for the user's purpose in referencing that resource. A user is also interchangeably referred to herein as an author.

Periodically, from time-to-time, upon the occurrence of some pre-designated event, or on demand, another embodiment crawls through the referenced resources in a corpus to ensure that the referenced resources still contain information similar to what was previously identified as useful and as a reason for inclusion of the resource into the corpus. In this way, the illustrative embodiments automatically verify the referenced resources based on observed content and their meaning with the progression of time. By providing a framework for defining and maintaining associations between the references and the resources, the illustrative embodiments provide a more robust, relevant, efficient, and consistent experience when using the material from referenced resources of a corpus.

A method for automatic management of misaligned references in a corpus, according to the illustrative embodiments, comprises two main actions: First, the ability to create a new association with (reference to) a resource or update a known association with a resource; and Second, the ability to automatically scan through known associations in a corpus to identify opportunities for improvement of the corpus—such as by replacing the associated resource with a better resource or by recategorizing the topics of the existing resource.

One embodiment reduces an identified resource to a set of tokens, or topics. The embodiment allows a user to select one or more topics for the list of topics, or to assign relative weights or significance/importance of the identified topics. The embodiment associates the user's topic selections or topic weights with the resource as a reason for the selection of the resource and ultimately for inclusion of the resource into the corpus.

One embodiment uses Document Topic Extraction (DTE) to extract topics from the resource contents. The extracted list of topics is used to prompt the user for weighting or selection. In one embodiment, a user is also enabled to provide an input to add a topic to the list of extracted topics where the user believes the topic was not automatically detected or included in the list.

One embodiment maintains a repository of content from the resources that are referenced, or known, in the corpus. The embodiment uses the repository to compare the contents of a newly-identified resource with one or more already-known resources to determine whether the newly identified resource is a duplicate, is borrowing from, or another generation of a resource already known in the corpus.

When the embodiment finds that the newly identified resource is an improvement over a known resource—for example, a newer generation, more detailed, more recently updated, from a better provenance, has better readability, cites more or better authority, or is improved over the known reference in any suitable manner, the embodiment suggests the newly identified reference for inclusion in the corpus. In one embodiment, the suggestion is made to the user. In another embodiment, the newly identified resource is used to automatically update or replace the known resource. The suggestion or automatic inclusion can be used for future updates for the topic(s) of interest related to the known resource and such updates can be propagated throughout the corpus to improve consistency of data within the corpus.

An example situation where such an operation is useful is when a known reference is a blog. During a comparison the embodiment might determine that the blog, which is the known resource, itself references another more complete and up to date set of documentation on a topic of interest. One embodiment suggests including the set of documentation in the corpus instead of the blog. Another embodiment automatically replaces the reference to the blob with a reference to the set of documentation.

An embodiment performs a scan of known resources and their associations to determine if any known resource has changed or misaligned to require an action—either automatic action or an action by a user. A misaligned resource may be a rewritten web page, a removed or restructured resource, an updated resource with new material, or anything that may adversely affect an original set of requirements for including that resource in the corpus.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

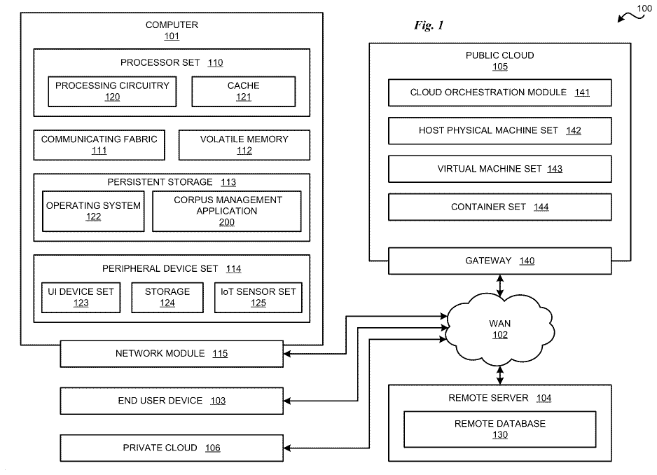

FIG. 1 depicts a block diagram of a computing environment 100. Computing environment 100 contains an example of an environment for the execution of at least some of the computer code involved in performing the inventive methods, such as corpus management application 200 that provides automatic management of misaligned references in a corpus in a manner described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

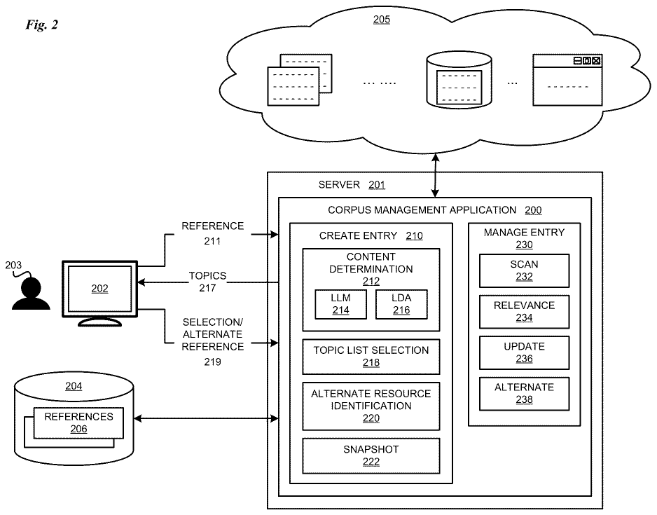

FIG. 2 depicts a block diagram of an example configuration for automatic management of misaligned references in a corpus in accordance with an illustrative embodiment. Server 201 is a representation of computer 101 or a computing facility capable of executing CMA 200 in a given data processing environment. Corpus Management Application (CMA) 200 is the same as CMA 200 in FIG. 1.

CMA 200 interacts with client device 202 for presenting topic lists and suggestions to user 203, and for obtaining user input from user 203. CMA 200 further manages repository 204 of references 206. A reference 206 may not only point to a distant resource located elsewhere on a network but may also include, and manage within repository 204, data related to the resource referenced by reference 206. For example, an embodiment may capture a snapshot of a resource referenced by reference 206 and save the snapshot along with reference 206 in repository 204. The snapshot may be an image, screen-scrape, or data capture by other means from the resource, such that the snapshot is usable by an embodiment to compare with a state of the same resource at a later time and determine whether the resource has changed.

Component 210 of CMA 200 enables the creation and inclusion of new references into repository 204. In an example operation, user 203 provides, via client device 202 reference 211 to be included in a corpus. Reference 211 points to a resource located in network 205. Content determination subcomponent 212 analyzes the content of the associated resource using Large Language Model (LLM) 214 and an implementation of Latent Dirichlet Allocation (LDA) 216 and extracts a set of topics from the contents of resource.

In one embodiment, the operation of subcomponent 212 involves identifying words in the resource which appear to carry weight with relation to other, nearby words. These words are known as tokens. These tokens are then vectorized using LDA's inbuilt TD-IDF (Term Frequency-Inverse Document Frequency) Vectorizer in order to build up a representation of the relation between the words. Once the LDA analysis begins, many iterations are performed in order to derive the most likely overall topics from the contents of the resource.

Subcomponent 212 provides topics list 217 to client device 202. Client device 202 returns response 219, which includes either a selection of topics from topics list 217 or a suggestion of an alternate reference. If response 219 includes a topics selection, subcomponent 218 associates the selected topics (and any corresponding topic weights, if returned in response 219) with the resource. Subcomponent 212 saves the reference to the resource, along with the selected topics, as an instance of reference 206 in repository 204.

If response 219 includes an alternate reference, subcomponent 218 finds the alternate reference in network 205 and processes, in the same manner, the initial reference - by analyzing the content, extracting and presenting a topics list, and receiving the selection of a topic based on the alternate reference. Subcomponent 212 saves the alternate reference, along with the selected topics, as an instance of reference 206 in repository 204.

Based on the selection of topics by user 203, subcomponent 220 identifies one or more alternate resources that might fit, or better fit, the selected topics. Again, an alternate resource identified in this manner is processed in the manner described here-by analyzing the content, extracting and presenting a topics list, and receiving the selection of a topic based on the alternate resource. Subcomponent 212 saves the reference to the alternate resource, along with the selected topics, as an instance of reference 206 in repository 204.

Snapshot subcomponent 222 captures a snapshot of the selected resource in a manner described herein. Subcomponent 222 saves the snapshot along with the instance of reference 206 that corresponds to the selected resource.

Component 230 manages the alignment of existing references in a corpus. In other words, component 230 operates to determine and remedy misalignments of references in a corpus. Subcomponent 232 scans the current version of the resource associated with a reference 206 in the corpus. Scan subcomponent 232 essentially implements a similar feature as, or utilizes the features of, subcomponent 212 - using LLM 214 and LDA 216.

Subcomponent 234 determines the relevance of the current version of the resource given the selected topic(s) and, optionally, the topic weights that were originally associated with that instance of reference 206. If the current version of the resource remains relevant to those topics up to at least a threshold degree, subcomponent 236 updates the instance of reference 206 to correspond to the current version of the resource. If the current version of the resource has become less relevant to those topics, e.g., the relevance falling below the threshold degree, subcomponent 238 identifies an alternate resource in the manner of subcomponent 220. CMA 200 then processes the alternate resource as described earlier. The reference to the older less relevant resource is removed and replaced with a new reference 206 if the alternate resource is accepted.

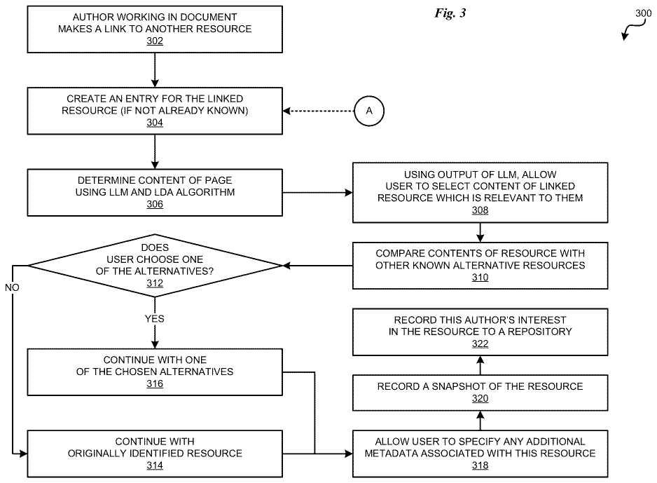

FIG. 3 depicts a flowchart of an example process for creating a new reference in accordance with an illustrative embodiment. Process 300 can be implemented in in CMA 200 in FIG. 2.

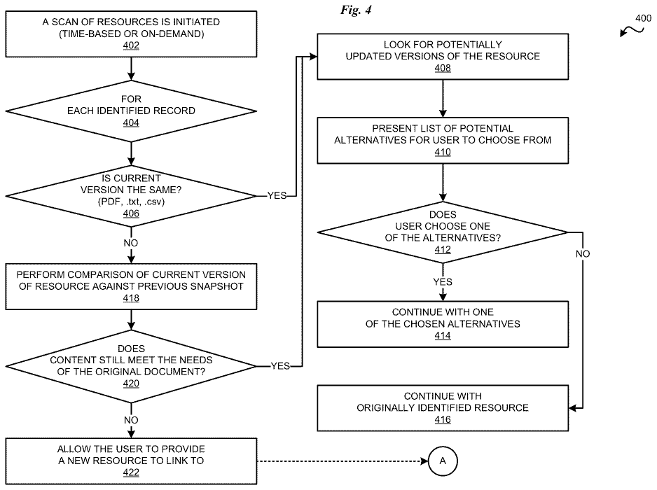

The process detects that a new reference has been made or supplied (block 302). The process creates a new entry for the reference if the reference is not already known in the corpus (block 304). Another process, such as process 400 of FIG. 4 can enter process 300 at block 304 via entry point A. The process determines the content of the referenced resource, using LLM and LDA in a manner described herein (block 306).

Using the output of the LLM the process presents a list of topics to the user from which the user selects one or more topics to indicate the relevance of the resource to the user (block 308). The process compares the contents of the resource with other alternative resources and offers the alternative resources (with the corresponding topics list) to the user for possible alternative selection (block 310).

The process determines whether the user chose an alternative resource, such as by indicating a choice of topics from the list of topics associated with an alternative resource (block 312). If the user did not select any topic from an alternative resource (“No” path of block 312), the process continues with the originally identified resource (block 314). If the user selects a topic from an alternative resource (“Yes” path of block 312), the process continues with the alternative resource (block 316).

The process accepts optional input from the user, such as an additional topic that was not identified automatically in the selected resource (block 318). The process also records a snapshot of the resource (block 320). The process creates an entry of the reference, the selected topics, and the snapshot in a corpus, such as using repository 204 in FIG. 2 (block 322).

FIG. 4 depicts a flowchart of an example process for automatic management of the alignment of references in a corpus in accordance with an illustrative embodiment. Process 400 can be implemented in CMA 200 in FIG. 2.

The process scans the known resources referenced in a corpus (block 402). The scan can be periodic, sporadic, event-based, or on demand. For each record of reference (block 404), such as an instance of reference 206 in repository 204 in FIG. 2, the process performs steps 406-422 as follows—

The process obtains a current version of the resource and compares the current version with the original version of the resource from the time the resource was entered in the corpus (block 406). For example, the process performs block 406 by comparing a snapshot in repository 204 with the contents of the current version of the resource.

If the current version of the resource is within a threshold level of similarity with the original version in the corpus (“Yes” path of block 406), the process searches for updated version of the resource or an alternative resource that might provide updated content for the selected topics from the original resource (block 408). The process presents the potential updated and/or alternative resources along with the corresponding list of topics generated in the manner described earlier (block 410).

The process determines whether the user selected one of the alternative resources (block 412). If the user selects one of the alternative resources (“Yes” path of block 412), the process continues in a manner described herein with the selected alternative resource (block 414). If the user does not select one of the alternative resources (“No” path of block 412), the process continues in a manner described herein with the originally identified resource (block 416).

Returning to block 406, if the current version of the resource is not within a threshold level of similarity with the original version in the corpus (“No” path of block 406), the process performs a comparison of the current version of the resource with the stored snapshot version of the resource to determine the changes in the resource (block 420). The process determines whether the current version of the resource still meets the original requirements from the resource—such as an acceptable level of coverage of the topics of interest (block 422). If the current version does not meet the original requirements (“No” path of block 420), the process allows the user to supply a new reference to a new resource. The process then enters process 300 via entry point A and operates in a manner described with respect to FIG. 3.

Optionally, even if the current version provides acceptable coverage of the topics of interest (“Yes” path of block 420), the process can be implemented to search for improved resources via blocks 408-416. In one embodiment, both “Yes” and “No” branches of block 420 may be followed after block 418.

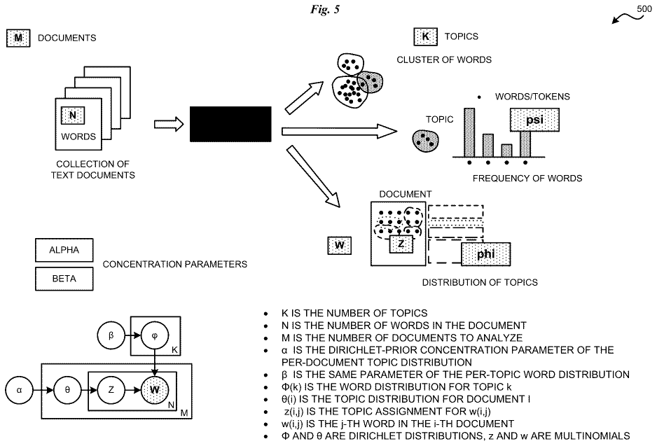

FIG. 5 depicts a block diagram of an example implementation for LDA in accordance with an illustrative embodiment. This implementation can be implemented for the purposes of topic modeling using LLM 214 and LDA 216 subcomponents depicted in FIG. 2 and as described therein.

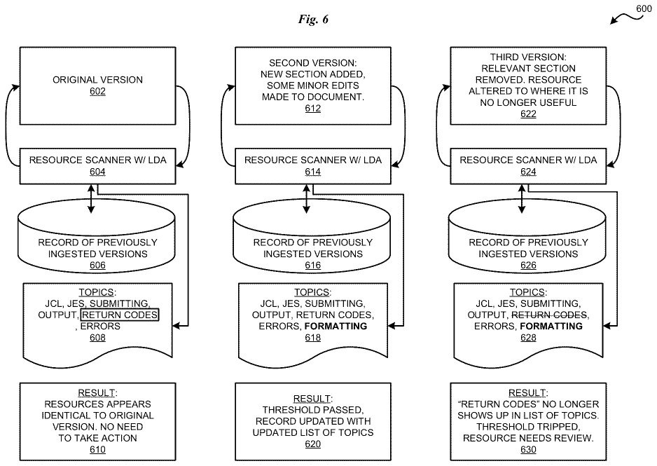

FIG. 6 depicts block diagrams of example circumstances in the automatic management of misaligned references in accordance with an illustrative embodiment. The depicted operations can be implemented in CMA 200 of FIG. 2.

In the first scenario, assume that an original version (602) of a resource is in a corpus. At some point in time after the original resource has been included in the corpus, an embodiment scans (604) the current contents of the resource—using LLM and LDA as described herein. The embodiment compares (606) the contents with an existing record of the known resource in the repository.

The embodiment identifies the list of topics in the current version of the known resource. Only as an example, assume that the original resource pertains to a tutorial on Job Control Language (JCL). A list of topics (608) is found in the current version of the resource. The user had previously indicated an interest in the topic “Return codes” from the resource (as indicated by the highlight box around the selected topic).

The embodiment finds that the list of topics still present in the current version is substantially the same as that in the version that is in the corpus. The embodiment takes no action with respect to the current version.

In a second scenario, assume that at some point in time after the original resource has been included in the corpus, a second version (612) of the known resource is found on the network. An embodiment scans (614) the current contents of the resource—using LLM and LDA as described herein. The embodiment compares (616) the contents with an existing record of the known resource in the repository.

The embodiment identifies the list of topics in the current version of the known resource. Continuing with the example resource pertaining to JCL tutoring, assume that a list of topics (618) is found in the current version of the resource that includes additional topics (as indicated by the bold highlight on the new topic). The user had previously indicated an interest in the topic “Return codes” from the resource (as indicated by the highlight box around the selected topic) and that topic is still present in the second version 612.

The embodiment finds that the list of topics still present in the second version passes a threshold degree of relevance for including the topic(s) of interest. The embodiment does not replace the reference in the corpus but updates the list of topics found in the second version.

In a third scenario, assume that at some point in time after the resource in the corpus has been updated with second version 612, a third version (622) of the known resource is found on the network. An embodiment scans (624) the current contents of the resource - using LLM and LDA as described herein. The embodiment compares (626) the contents with an existing record of the known resource in the repository.

The embodiment identifies the list of topics in the current version 622 of the known resource. Continuing with the example resource pertaining to JCL tutoring, assume that a list of topics (628) is found in the current version 622 of the resource that includes additional topics (as indicated by the bold highlight on the new topic). The user had previously indicated an interest in the topic “Return codes” from the resource, which is now not present in the current version 622 of the resource (as indicated by the strike through the selected topic).

The embodiment finds that the list of topics present in the third version fails to pass a threshold degree of relevance for including the topic(s) of interest. The embodiment indicates to the user that the reference in the corpus should be reviewed, and a replacement should be found.

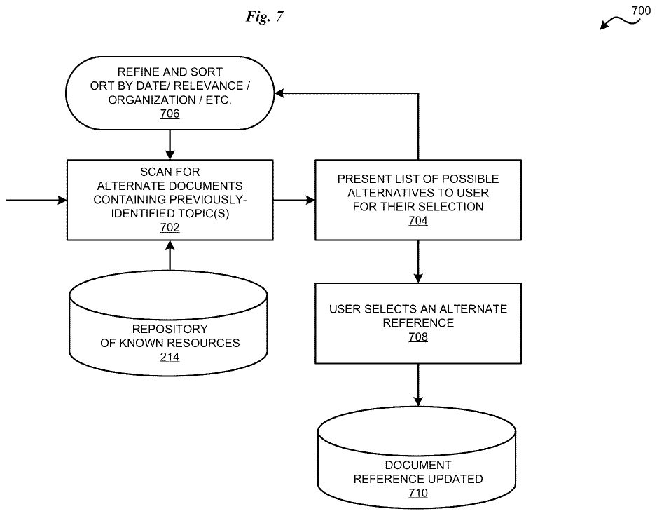

FIG. 7 depicts an example process of replacing a resource in a corpus in accordance with an illustrative embodiment. Process 700 can be implemented using CMA 200 in FIG. 2.

The depicted process executes at a stage for presenting the user with alternate resources in case their previously identified resources are deemed no longer relevant. The process starts by looking in the repository of known resources (every resource that's ever been identified in the system) for resources with similar sets of topics (block 702). The repository is similar to repository 214 in FIG. 2. The process presents the suggestions to the user (block 704).

The user may wish to refine sort the returned list of alternatives until the user is satisfied (block 706), or select an alternate resource that is presented (block 708). The user may also decide not to accept the alternate recommendation(s) and may elect to enter in a new document reference. Depending on the choice of the user, the process updates the repository (block 710).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
extracting, by inputting textual content of a second resource into a Large Language Model (LLM) operating in conjunction with a topic identification module, a second set of topics represented in the second resource;
comparing the second set of topics with a first set of topics associated with a first resource and stored in a data repository;
determining, responsive to the comparing, that a previously selected topic in the first set is absent in the second set of topics;
selecting an alternate resource such that the alternate resource includes the previously selected topic; and
causing a reference to the first resource in the data repository to be redirected to the alternate resource.

2. The computer-implemented method of claim 1, further comprising:
selecting a plurality of alternate resources based on the first set of topics; including the alternate resource; and
selecting the alternate resource from the plurality of alternate resources based on a user input.

3. The computer-implemented method of claim 1, wherein the second resource is a later version of the first resource.

4. The computer-implemented method of claim 1, wherein the topic identification module implements a Latent Dirichlet Allocation (LDA) algorithm.

5. The computer-implemented method of claim 1, further comprising:
further extracting, from a second alternate resource a third set of topics represented in the resource;
further comparing the third set of topics with a set of topics associated with the alternate resource and stored in a data repository;
further determining, responsive to the further comparing, that the third set of topics is different from the set of topics associated with the alternate resource and that the third set of topics includes the previously selected topic; and
omitting, responsive to the third set of topics including the previously selected topic, replacing the alternate resource with the second alternate resource.

6. The computer-implemented method of claim 5, wherein the third set of topics is different from the set of topics associated with the alternate resource by at least one of (i) including a new topic, and (ii) removing an unselected topic.

7. The computer-implemented method of claim 1, further comprising:
causing, as a part of redirecting to the alternate resource, a reference to the first resource in the data repository to be removed from the data repository;
adding a new reference to the alternate resource in the data repository; and
causing each occurrence of the reference to the first resource in the data repository to be replaced by the new reference.

8. A computer program product comprising one or more computer readable storage media, and program instructions collectively stored on the one or more computer readable storage media, the program instructions executable by a processor to cause the processor to perform operations comprising:
extracting, by inputting textual content of a second resource into a Large Language Model (LLM) operating in conjunction with a topic identification module, a second set of topics represented in the second resource;
comparing the second set of topics with a first set of topics associated with a first resource and stored in a data repository;
determining, responsive to the comparing, that a previously selected topic in the first set is absent in the second set of topics;
selecting an alternate resource such that the alternate resource includes the previously selected topic; and
causing a reference to the first resource in the data repository to be redirected to the alternate resource.

9. The computer program product of claim 8, the operations further comprising:
selecting a plurality of alternate resources based on the first set of topics; including the alternate resource; and
selecting the alternate resource from the plurality of alternate resources based on a user input.

10. The computer program product of claim 8, wherein the second resource is a later version of the first resource.

11. The computer program product of claim 8, wherein the topic identification module implements a Latent Dirichlet Allocation (LDA) algorithm.

12. The computer program product of claim 8, the operations further comprising:
further extracting, from a second alternate resource a third set of topics represented in the resource;
further comparing the third set of topics with a set of topics associated with the alternate resource and stored in a data repository;
further determining, responsive to the further comparing, that the third set of topics is different from the set of topics associated with the alternate resource and that the third set of topics includes the previously selected topic; and
omitting, responsive to the third set of topics including the previously selected topic, replacing the alternate resource with the second alternate resource.

13. The computer program product of claim 12, wherein the third set of topics is different from the set of topics associated with the alternate resource by at least one of (i) including a new topic, and (ii) removing an unselected topic.

14. The computer program product of claim 8, the operations further comprising:
causing, as a part of redirecting to the alternate resource, a reference to the first resource in the data repository to be removed from the data repository;
adding a new reference to the alternate resource in the data repository; and
causing each occurrence of the reference to the first resource in the data repository to be replaced by the new reference.

15. The computer program product of claim 8, wherein the stored program instructions are stored in a computer readable storage device in a data processing system, and wherein the stored program instructions are transferred over a network from a remote data processing system.

16. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

17. A computer system comprising a processor and one or more computer readable storage media, and program instructions collectively stored on the one or more computer readable storage media, the program instructions executable by the processor to cause the processor to
extracting, by inputting textual content of a second resource into a Large Language Model (LLM) operating in conjunction with a topic identification module, a second set of topics represented in the second resource;
comparing the second set of topics with a first set of topics associated with a first resource and stored in a data repository;
determining, responsive to the comparing, that a previously selected topic in the first set is absent in the second set of topics;
selecting an alternate resource such that the alternate resource includes the previously selected topic; and
causing a reference to the first resource in the data repository to be redirected to the alternate resource.

18. The computer system of claim 17, the operations further comprising:
selecting a plurality of alternate resources based on the first set of topics; including the alternate resource; and
selecting the alternate resource from the plurality of alternate resources based on a user input.

19. The computer system of claim 17, wherein the second resource is a later version of the first resource.

20. The computer system of claim 17, wherein the topic identification module implements a Latent Dirichlet Allocation (LDA) algorithm.
